(19) United States
(12) Patent Application Publication
(10) Pub. No.: US 2010/0177382 A1
(43) Pub. Date: Jul. 15, 2010

(54) AUTOSTEREOSCOPIC IMAGE DISPLAY APPLIANCE FOR PRODUCING A FLOATING REAL STEREO IMAGE

(75) Inventors: Rene De La Barre, Mittweida (DE); Siegmund Pastoor, Berlin (DE); Hans Roder, Berlin (DE)

Correspondence Address: SCHWEGMAN, LUNDBERG & WOESSNER, P.A., P.O. BOX 2938, MINNEAPOLIS, MN, 55402, US

(73) Assignee: Fraunhofer-Gesellschaft zur Forderung der angewandten Forschung e.V., Munchen (DE)

(21) Appl. No.: 12/526,207

(22) PCT Filed: Jan. 16, 2008
(86) PCT No.: PCT/EP2008/000270

§ 371 Date: Mar. 4, 2010

(30) Foreign Application Priority Data
Feb. 7, 2007 (DE) 10 2007 006 038.8

(51) Int. Cl. G02B 27/22

(52) U.S. Cl. 359/463

(57) ABSTRACT

Known image display appliances with relatively large appliance depth have parallel lens plates with rotation-symmetrical microlenses, wherein a real stereo image could be made visible directly using a matt screen by way of the microlenses optically imaging the non-inverted, non-rastered image information. Known image display appliances with a cylinder lens plate, the cylinder lenses of which image linearly, have hitherto not been used to produce a floating real stereo image. The image display appliance (BWG) according to the invention with a cylinder lens plate (ZLP) and a corresponding alternating raster of left and right image strips (BSR) is characterized in that each image strip (BSR) is displayed as side-inverted with respect to its arrangement in the original image information, and in that all image strips (BSR) are positioned with such gaps (R, r) to their two neighbouring image strips (BSR) on the display screen (BS) that the observer in the stereo image plane (SBE) which lies between the cylinder lens plane (ZLE) and the observer eye plane (BAE) obtains a gapless representation of the image information in the form of a floating real stereo image (SB). Advantageously, equidistant distances between the image strips (BSR) can be selected. Real articles which can be detected together by the observer without accommodation conflict (mixed reality applications) can be introduced into the stereo image plane

The invention relates to an autostereoscopic image display appliance with a screen and a cylinder lens plate for displaying image information for the right eye and the left eye of an observer in the form of alternating image strips of the same width which respectively form pairs of image strips, lateral reserve zones being assigned to each image strip and the cylinder plate being disposed in front of the screen such that only the associated image information becomes visible for each eye.

### STATE OF THE ART

In the case of the autostereoscopic display methods which can be used in many ways for example for information and communication technology, medical technology and computer and video technology both in the public and in the private sphere, the overall complexity of the correct eye depending stereo separation is performed in the method and in the converting system itself; additional user-associated hardware, for example spectacles, are not required, as a result of which the comfort of the user is substantially increased. The principle of autostereoscopic display methods is based on scanning of different image views on a screen (for example flat screen, LCD or plasma screen) and optical separation of these scanned views in the direction of the eyes of an observer so that always only portions of a single image view are detected by each eye in an optical context and are combined together to form a perspective view. The separating raster has many adjacently disposed separating elements for this purpose, for example separating strips, slots, cylinder lenses or prisms. In the case of the present invention, a cylinder lens plate is used as separating raster and the image information is segmented into image strips. Cylinder lenses have in fact the fundamental property of imaging a point as a line. An image strip imaged by a cylinder lens therefore comprises superposition of a large number of lines which correspond to the pixels in the image information in the image strip. However, the human eye is able to filter out the original image information from the superposition.

In the case of all conventional autostereoscopic cylinder lens screens, the virtual stereo image is produced directly on the lens raster. The stereo scene can however be placed, by means of suitable choice of perspectives in the left and right stereo image, apparently in front of the lens raster. The eyes of the observer then focus on the lens raster and his eye axes converge in front of the lens raster in the stereo scene. In order to avoid this accommodation conflict, the stereo scene is placed in the lens raster in the case of known screens. Displays of objects which protrude from the cylinder lens screen or even float in front of the latter, for example in product sheets, serve to illustrate the autostereoscopic properties of the screen. A floating stereo image is not produced.

The combination of the divergent light beams emanating from an object point into one point, the image point, is termed optical imaging. Therefore imaging means beam combination. This is effected more or less precisely by lenses, mirrors or a combination of both—the optical system. If the combining points of the beams can be picked up by a screen, the imaging is termed real, a real image is present. The structure made up of the real beam intersection points in space is often also termed “aerial image”. If the beams emanating from an object point leave the optical system divergently and only their rear extensions intersect in an apparent point, the imaging is termed virtual. Virtual images cannot be picked up on a screen but can be seen because the eye lens makes the divergent beam bundle convergent again and produces a real picture on the retina. An everyday example of a virtual image is the mirror image. In contrast to virtual images, real aerial images are not an everyday phenomenon. This is due, on the one hand, to the fact that more complex optical systems are required in general for production thereof, on the other hand, the conical pencils of rays through the real image points have generally very small aperture angles. In order however to be able to see the real image, the eye must be situated in this cone of radiation—even directly adjacently, the real image is invisible. For this reason, widely scattering image walls are used in image projection in order to show real images.

The stereoscopic projection into a floating plane (“aerial image plane”) has been known for a long time. A simple arrangement comprises two projection units and a large (Fresnel) lens. The projection units—respectively an image display and a projection lens—project the image display for the right eye and that for the left eye through the large (Fresnel) lens, and in fact such that both images are situated directly one upon the other. The two projection lenses are likewise imaged in a real manner by the (Fresnel) lens (“pupil images”). The sequence in the projection direction is then: image display—projection lens—real aerial images—images of the projection lenses. The two adjacently situated real “pupil images” are the “peepholes” through which the observer can see the stereo image.

As an alternative to the (Fresnel) lens used in these methods, a large spherical mirror can also be used (cf. for example DE 699 00 470 T2). The local invariance of the pupil imaging has to date only been able to be treated by mechanical tracking of the entire projection device or by parts of the same. In general, these methods are characterised by their long projection paths and the large dimensions of the autostereoscopic projection appliance (cf. for example US 2004/0227992 A1).

To date, no autostereoscopic image display appliance with a cylinder lens plate, with the help of which a real stereo image can be produced in a stereo image plane situated in front of the cylinder lens plate, is known from the state of the art. Rather, such arrangements are known, in which, with the help of a large number of rotationally symmetrical microlenses which are disposed in an array adjacently and one above the other, a real stereo image which floats in a stereo image plane situated in front of the microlens array is produced (cf. U.S. Pat. No. 6,771,231 B2). Two microlens arrays are thereby placed one in front of the other, which implies doubling of complexity for the complex lens plate. Due to the optical imaging of the non-inverted original image information with rotationally symmetrical microlenses, the real stereo image could not be made visible directly with a ground glass screen. The human eye does not need to perform a filtering process. The microlens array is however disposed at a relatively large spacing in front of the screen so that a relatively large appliance depth is produced for the entire image display appliance.

Due to the position of the produced stereo image in front of the microlens array, no accommodation conflict results with concrete objects disposed in the region of the stereo image plane (cf. U.S. Pat. No. 6,771,231 B2, FIG. 3: two fir trees 31 in the region of the stereo image plane 30 with the stereo image P in the form of a car). The accommodation conflict describes the problem of decoupling of accommodation and convergence behaviour of the eyes. The focusing of the individual eyes at a specific visual distance is thereby understood by accommodation. In contrast, the attempt of the human visual system to orientate the lines of sight of both eyes on one point is termed convergence behaviour. When observing a point in a real scene, the accommodation distance is equal to the convergence distance. In the case of a stereoscopic image display appliance, the different points of a spatial scene are however imaged in a common focal plane independently of their spatial depth. The accommodation distance is therefore equal for all points. On the other hand, the convergence distance is however dependent upon the spatial depth of the observed point and hence varies. Because of this contradictory information, the result is accommodation conflict which can rapidly lead to visual fatigue in the observer (cf. DE 195 37 499 C2).

A basic feature in the invention is the cylinder lens plate used as separating raster. Since a large number of autostereoscopic image display appliances with a cylinder lens plate is known from the state of the art, which appliances are basically suitable with all their properties and possibilities (for example tracking) for conversion of the invention, the invention starts from the subsequently mentioned publication as closest state of the art.

A generic autostereoscopic image display appliance with a screen and a cylinder lens plate is known from DE 198 27 590 C2. The image information for the right eye and the left eye of an observer are represented in the form of image strips of the same width which are disposed alternately interleaved on the screen (image stripes //left eye/right eye//left eye/right eye// etc.). An image strip for the left eye and the associated image strip for the right eye always thereby form an image strip pair. The cylinder lens plate has cylinder lenses which are adapted to the image strips and is disposed in front of the screen such that only the associated image information is visible for each eye. Furthermore, it is known from DE 198 27 590 C2 to compensate for position changes by means of a redundant display of image views. For this purpose, lateral reserve zones are assigned to each image strip. As a result, the correct and complete image information is then also offered to each eye of the observer if the observation position is varied within specific limits without the cylinder lens plate requiring to be readjusted mechanically. Furthermore, the image information of the observer's head position can be adapted and tracked (tracking). A floating real stereo image however is not produced with this image display appliance with a cylinder lens plate either.

### OBJECT

The object of the invention therefore resides, starting from the initially described generic autostereoscopic image display appliance with cylinder lens plate, in making available a developed autostereoscopic image display appliance with which a floating real stereo image can be projected into a stereo image plane situated in front of the cylinder lens plate. However, relative to known devices for producing floating stereo images, the image display appliance with a cylinder lens plate is thereby intended at the same time not to lose its normal—very small—constructional depth, its large-area projection lens and its otherwise known positive properties, such as for example the observer-tracked image display. The projection path produced is also intended to be so short that the stereo image plane is situated between the cylinder lens plate and the observer so that the latter can access the stereo image plane for example with his hand whilst seated comfortably in front of the image display appliance (mixed reality display).

The solution according to the invention to this object can be deduced from the main claim. Advantageous developments of the invention are displayed in the sub-claims and explained subsequently in more detail within the context of the invention.

The autostereoscopic image display appliance according to the invention with a screen and a cylinder lens plate is characterised by two basic features:
each image strip is displayed side-inverted relative to its arrangement in the original image information and
all image strips are positioned with such gaps relative to their two adjacent image strips on the screen that the observer, in the stereo image plane situated between the cylinder lens plane and the observer eye plane, obtains a continuous display of the image information in the form of a floating real stereo image.

In addition to the special representation of the image strips, feature 2) is therefore achieved exclusively by changing the spacings of the individual image strips relative to each other. In practice, such a variation is achieved by the geometric parameters of the image display appliance and the relation between the observer and the image display appliance so that the latter maintains its basic conception—in particular its small constructional depth and its large projection lens system. An embodiment can be deduced from the special part of the description.

The display appliance according to the invention enables a 3D display for an individual observer. The display within the reach of the observer makes possible perception of the displayed virtual objects and of the real objects situated in the immediate vicinity thereof, such as tools or observer's hands, which is free of accommodation and convergence conflicts. Hence virtual objects can be experienced directly by the observer from the image information and no longer related to the cylinder lens plate so that virtual and real objects perceived in the same range by the observer can be seen in sharp focus likewise without visual conflict. The autostereoscopic display appliance according to the invention hence makes it possible for the first time to have a mixed reality display which is highly comfortable for the observer. The stereoscopic display of spatial scenarios thereby corresponds to natural vision and enables precise assignment of the objects in space in fact. This is increased even more with the invention in that the image information to be displayed can be seen together with real objects as a real stereo image floating in the air and which the observer can access. The result is therefore for the autostereoscopic image display appliance according to the invention a large field of use (for example 3D desktop displays for medical and vehicle technology, molecular design, virtual glass display cases in museums, event visualisation, gaming appliances in amusement arcades, game consoles for the gaming industry).

By means of the reserve zones provided laterally of the image strips, even lateral head movements can be tolerated within a prescribed range. Greater lateral head movements and above all also head movements towards the screen can only be allowed with image tracking. As a result of reserve zones which are provided laterally on the image strips and with the image information of which the gaps between the image strips are filled, the advantage is thereby produced of being able to allow a certain tolerance relative to small head movements of the observer and delay times and also small imprecisions in detection (image contents remain stationary, merely the non-visible edges of the reserve regions migrate). For this reason, there belongs to the preferred embodiments of the invention, in addition to specific preferred establishments of special parameters of the image display appliance according to the sub-claims 2, 3 and 4—for example establishment of equidistant spacings between all the image strips—also the provision of a tracking device for adapting the image display to movements of the observer parallel to the screen and/or in space. With the image display appliance, both image tracking in the x-y plane and in addition at a spacing from the screen is therefore possible. In particular electronic tracking methods are known sufficiently from the state of the art. Electronic tracking of the eye positions of the user enables sufficient movement play for head movements and makes it possible correspondingly to display the spatial representation of the image information of the observer position, as a result of which a “look around” display (dynamic perspective) is made possible. The optical tracking of the image display for the left and right eye of the observer is thereby effected fluently without perceptible switching effects through shadow zones and without instead components of the autostereoscopic image display appliance requiring to be moved mechanically.

By means of electronic tracking of the objects within the perception field or the observer's hand, it is intended to be ensured that naturally operating mixed reality interactions and direct manipulation of the virtual object or of the virtual scene can be performed by hand or with real tools. When tracking the observation zones, the image contents can thereby be shifted on the display, dependent upon the position. The current view on objects and scenes displayed as image information can be changed as a function of the head position of the observer. The arrangement of the image contents can be effected within the mutually alternating left and right image strips, hence go beyond the individual image strips. In particular tracking of the image information in the case of distance changes of the observer (and also for adaptation to the individual eye spacing of the observer) can also be effected by changing the width of the image strips and the widths of the lateral reserve regions. Electronic tracking is technically relatively easy to achieve with commercially available components. Special multiplex schemes in the assignment of the individual pixels in the image strips fulfil the requirements of electronic tracking very well and can be implemented easily both in the graphics card and in a combination of format converter hardware and graphics card. When combined, it is possible to use a normal stereo format without a special driver, to perform the adaptation of the stereo views in the graphics card and to implement the interleaving of the image strips in the format converter. When producing multiplex schemes, the render parameters can be changed such that all displayed objects (virtual and real) appear spatially stable and of the same size to the moving observer.

Furthermore, in the image display appliance according to the invention, a detection device can preferably be provided for location detection of concrete objects in the region of the stereo image plane. In the mixed reality display, for example commands can be triggered by such a detection.

Finally, the image strips and cylinder lenses can also preferably extend diagonally (slanted raster), as a result of which a reduction in cross-talk between the adjacent stereo channels results. In the reserve zones, strip conductors, transistors and other visible structures can be integrated in the screen and therefore are not disruptive within the pixel aperture. Hence also conventional screens can be used and the result is good investment security.

### EMBODIMENTS

In the subsequent special part of the description, the crucial physical conditions and the parameter settings resulting therefrom for an autostereoscopic image display appliance comprising a flat screen and a lens raster plate, fitted in front, with a series of cylinder lenses disposed parallel to each other are presented in more detail according to the invention in preferred embodiments with reference to schematic Figures. There are thereby shown:

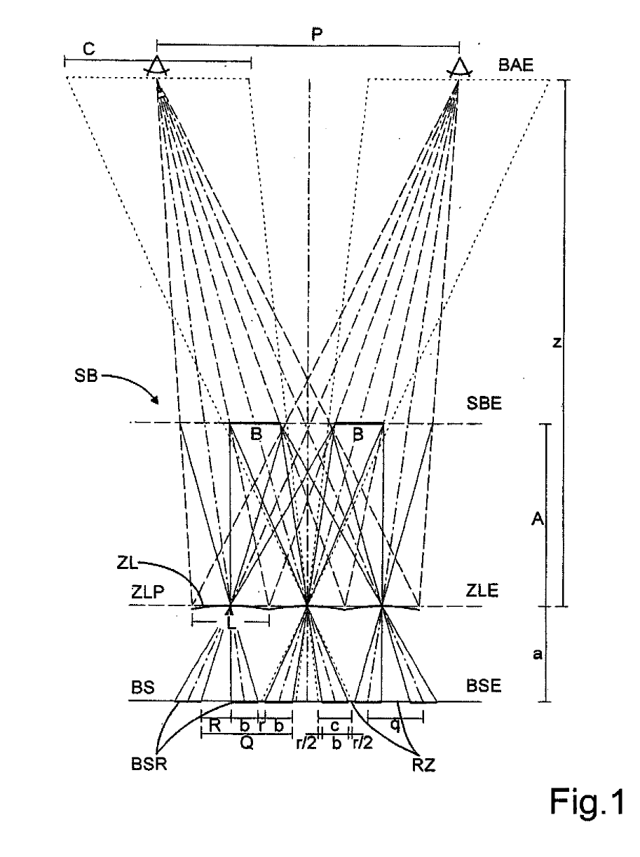

FIG. 1 the geometric parameters of the image display appliance,

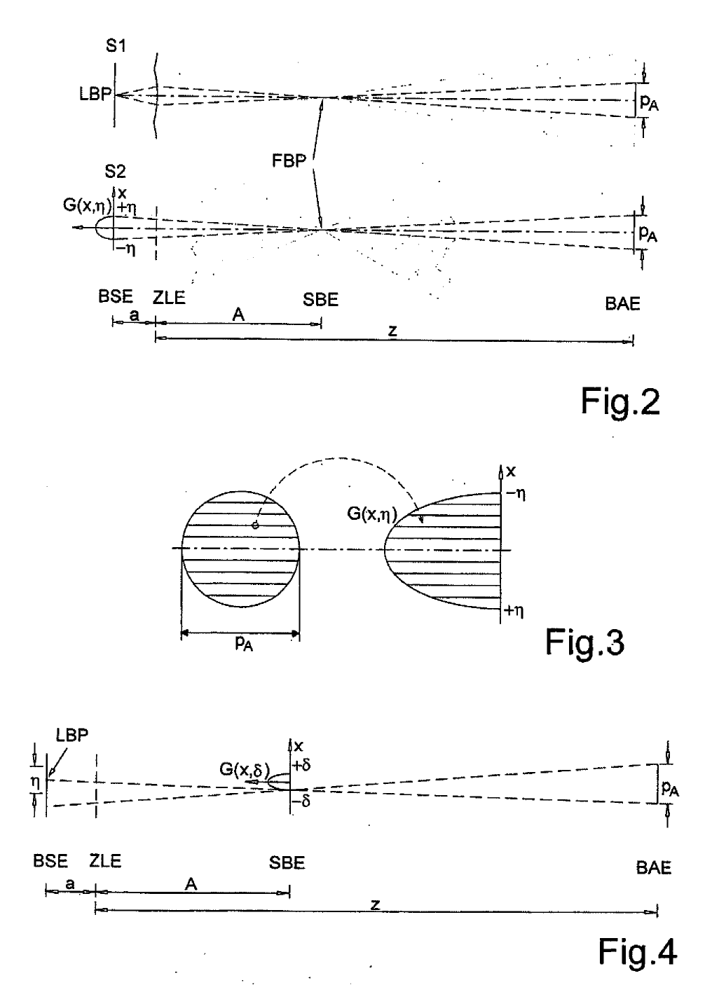

FIG. 2 a diagram relating to the filtering property of the eye,

FIG. 3 a diagram relating to the weighting function,

FIG. 4 a diagram for the perception of the eye,

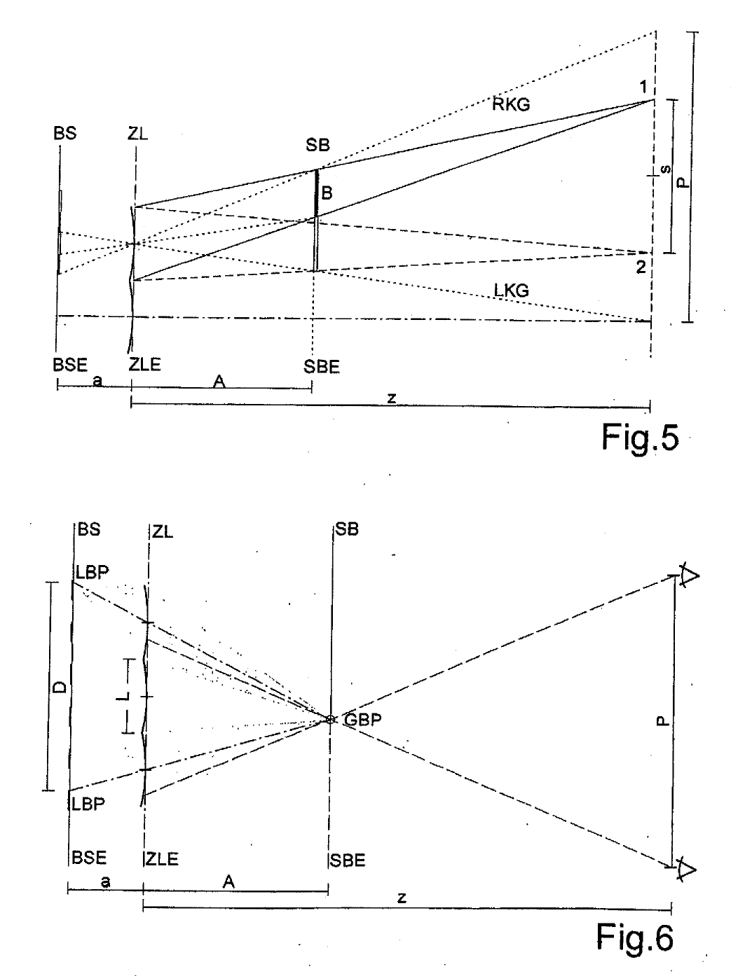

FIG. 5 the ray path in principle for a stereo channel,

FIG. 6 the geometric-optical imaging for two corresponding points at the edge of the right and left partial image,

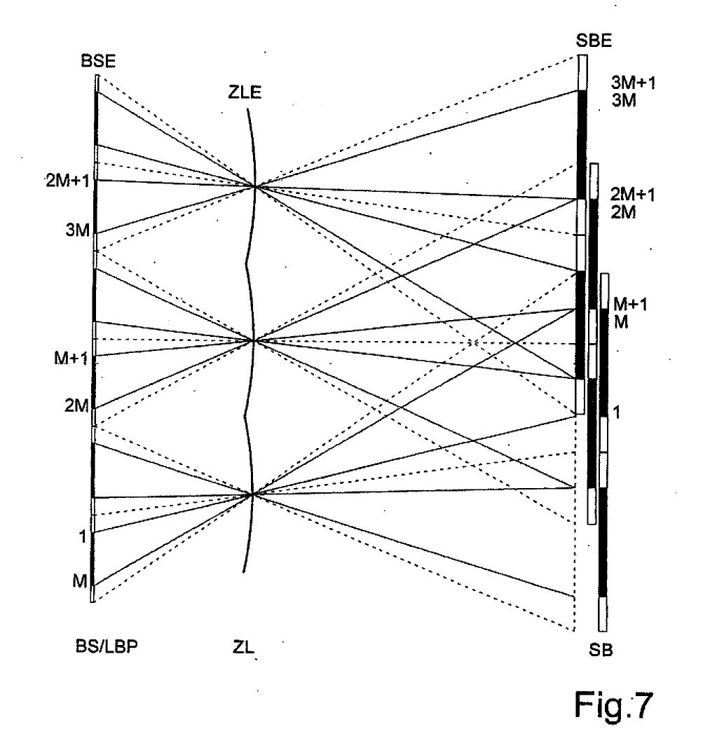

FIG. 7 a representation relating to filling of the image strips with image content,

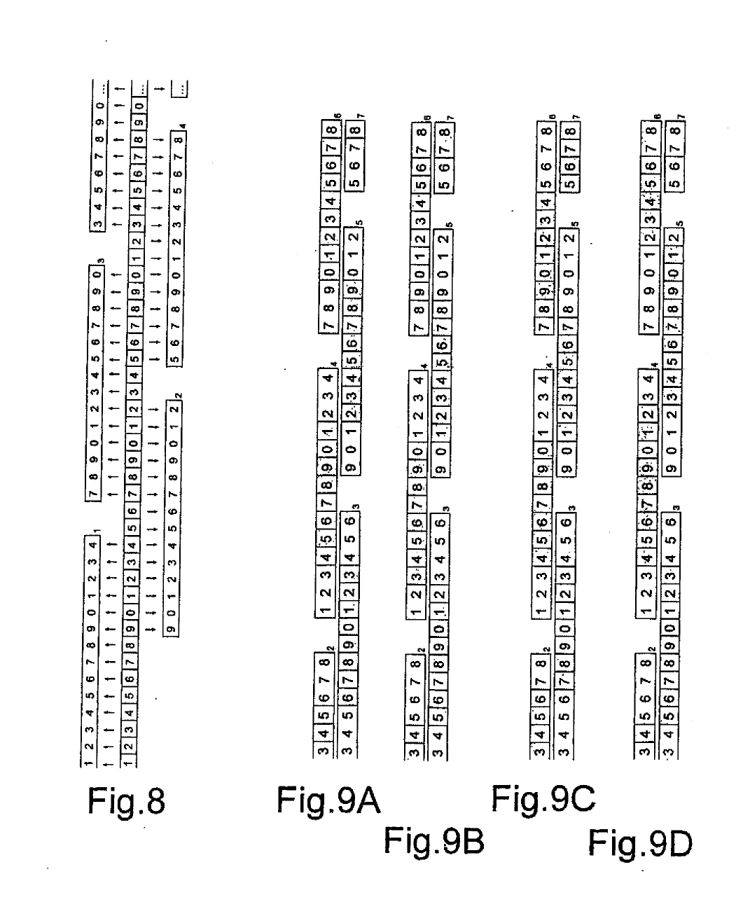

FIG. 8 an image line, surrounded above and below by the pixel groups read out therefrom, and

FIG. 9A-D an image line with image strips projected one on the other with different tracking.

The geometric parameters of the image display appliance BWG are represented in FIG. 1. The screen plane BSE (screen BS), the cylinder lens plane ZLE (cylinder lens plate ZLP), the stereo image plane SBE and the observer eye plane BAE are shown. On the flat screen BS, two images—one for the right and one for the left eye—are displayed fanned out one in the other in strips as image information. In front of the screen BS, a cylinder lens plate ZLP with parallel, equidistant cylinder lenses ZL is fitted at a spacing a (lens spacing). The longitudinal axes of the cylinder lenses ZL in FIG. 1 are perpendicular to the drawing plane. The cylinder lenses ZL are thereby all identical at present for technical manufacturing reasons and have the same lens pitch L (lens width) and the same radius of curvature. With advanced manufacturing technology, these parameters also are entirely variable.

Further parameters are explained in FIG. 1 in conjunction with the subsequent Figures.

A point (pixel) radiating in all directions on the screen BS is imaged by a cylinder lens ZL as a real straight line in the stereo image plane SBE. A large number of radiating points hence produces an entire series of such lines, each parallel to the longitudinal axes of the cylinder lenses ZL. In particular, all the points of the screen BS, which are situated on a straight line parallel to these axes, produce real lines which fall directly one on the other in the stereo image planes SBE. In the latter, an extensively structureless, diffuse lightness distribution is thus produced so that no image can be picked up with a ground glass screen. Although for instance the known definition of a real image on cylinder lenses ZL does not apply (“a real image can be imaged directly on a ground glass screen”) the imaging produced with the image display appliance nevertheless concerns a real image, in particular a real stereo image SB. The production of a real image with linearly imaging cylinder lenses ZL has to date not been dealt with in the state of the art so that the known definition cannot be applied to this type of imaging lens. The intensity image produced with cylinder lenses ZL of this type can however be readily filtered by the human eye. The pupil of the eye of the observer separates a comparatively sharp image from the innumerable images situated one above the other. This is intended to be illustrated with FIG. 2.

The sketch at the top in FIG. 2 shows a section S1 transversely relative to the axis of a cylinder lens ZL through a radiating image point LBP on the screen BS. The light radiated from this point only partly reaches the pupil PA of the eye. At the bottom in FIG. 2, the section S2 through the radiating image point LBP is situated parallel to the axis of a cylinder lens ZL—i.e. perpendicular to the drawing plane in FIG. 1. The divergent light in the focused image point FBP comes from the radiating image points LBP on the x-axis (out-of-focus in the direction of the axis of the cylinder lens ZL) which is identical to the intersecting line of drawing plane and screen plane BSE. Only the light of the light points from the region (−η, +η) on the x-axis reaches the eye. These points contribute to a different extent to the brightness in the stereo image: the light radiated from a radiating image point LBP perpendicular to the drawing surface—which can be seen in FIG. 2 at the top as a plan view—marks a chord in the round pupil of the eye. The length of this chord is proportional to the contribution which the radiating image point LBP makes to the brightness of the focused image point FBP in the stereo image SB on the screen BS. In FIG. 2, the incident light from the cylinder lens ZL of the radiating image point LBP is indicated in light grey.

This individual proportion can be described with a weighting function G (x, η) which displays the chord length of a circle with the radius n as a function of the spacing x thereof from the centre—see FIG. 3. The chord length divided by the area of the circle is the weighting function:

G(x, η)=2√[η²−x²]/(π η²) with |x|≦η (1)

The area under this function is equal to 1. The radius η corresponds to half the “foot width” of the function arc.

The observed point in the stereo image therefore radiates, with the mixed light of all radiating image points LBP of the portion (−η, +η) on the screen BS, weighted with G (x, η). This reduces the contrast and the colour reproduction in the stereo image—and in fact dependent upon the diameter of the pupil of the eye: the lighter the panel, the narrower is the pupil of the eye and the more rich in contrast and pure in colour is the stereo image.

In FIG. 4, the case is represented in which only a single point is radiating in the image strip BSR on the screen BS. The light from this point reaches the eye as soon as the observer looks at places within the stretch (−δ, +δ) on the stereo image plane SBE. When looking at the boundary points −δ or +δ, the light is in fact still perceptible—it enters then at the upper or lower edge of the pupil into the eye of the observer. FIG. 4 shows the case in which the eye focuses on the point −δ in the stereo image plane SBE.

The radiating point on the screen BS is therefore visible in the stereo image plane SBE as a more or less sharply delimited brightness distribution in the direction of the cylinder lenses ZL. This out-of-focus can be described in the same way as above via the chord length in the pupil of the eye, i.e. with the weighting function G (x, δ) and the “foot width” 2δ of the function arc. Applying here also is: the brighter the screen BS, the narrower is the pupil of the eye and the sharper the stereo image SB. The “foot widths” depend upon the spacings a (lens spacing) between screen plane BSE and cylinder lens plane ZLE, A (image spacing) between cylinder lens plane ZLE and stereo image plane SBE and z (observer spacing) between cylinder lens plane ZLE and observer eye plane BAE and also the diameter p_{A} of the pupil of the eye. According to FIG. 2 and FIG. 4 there applies:

η=(a+A)/(z−A)*p_{A} (2)

and

δ=(a+A)/(z+a)*p_{A} (3)

Also transversely relative to the axes of the cylinder lenses ZL, these do not image like dots, however the pupil of the eye also positively influences the image quality here. Estimation of this “blurring” is however possible only with extensive calculations.

Imaging by the Cylinder Lenses

For the imaging of the cylinder lenses ZL transversely relative to the cylinder axis—see FIG. 1 or FIG. 2—the known rules of optics apply. Each cylinder lens ZL forms an extended region of the screen BS—for example an image strip BSR—side-inverted in the stereo image plane SBE. The imaging scale is thereby equal to the ratio of image spacing A (between cylinder lens plane ZLE and stereo image plane SBE) to lens spacing a (between cylinder lens plane ZLE and screen plane BSE):

β=A/a (4)

However, only the image regions which are situated within the connection lines, pupil of the eye—right lens edge and pupil of the eye—left lens edge, are visible for the eye. These portions designated in FIG. 1 with B are determined by the observer spacing z and the image spacing A and also from the lens pitch L:

B=L*(z−A)/z (5)

On the screen BS, this corresponds to the distance:

b=L*(a/A−a/z) (6)

The two regions of a image strip pair (stereo pair) for the right and the left eye have the following spacing from each other on the screen BS:

q=P*a/z (7)

The periodic spacing of image strip pair to image strip pair corresponds to the projection of the lens pitch L on the screen BS, with the eye as projection centre. It is:

Q=L*(a+z)/z (8)

The gaps between the visible regions within the image strip pairs have the width q−b:

R=a*(L+P)/z−L* a/A (9)

The gaps of image strip pair to image strip pair have the width Q−q−b:

r=a*(2L−P)/z+L*(1−a/A) (10)

The spacings and widths determined by the equations (5) to (10) depend upon the parameters L, A, a and z. The first three parameters L, A and a thereof are fixed by the construction of the image display appliance BWG, i.e. constant. The spacing z depends, in contrast, upon the current position of the observer. This means that the widths B, b, R and r change if the observer changes his distance from the screen BS.

Lateral Movement of the Observer

If the observer moves laterally, then the pattern comprising image strips BSR and gaps is displaced on the screen BS in the opposite direction thereto. The visible regions thereby move already after the short stretch r to the places which are provided for the other stereo image. In order to avoid this, the image pattern of the lateral movement of the observer must be tracked in the ratio a/z.

This “tracking” demands all the greater precision the narrower is the small gap r: this should therefore be as large as possible. This is the case if both gaps are of equal width, i.e. R=r. According to formulae (9) and (10), this applies for the following spacing between lenses and panel:

a_{sym}=z*L/(2P−L) (11)

In this relation, the image spacing A between cylinder lens plane ZLE and stereo image plane SBE does not arise, the correspondence of the two gaps R, r therefore applies for each position of the stereo image plane SBE. In the case of such a screen BS, all the image strips BSR on the screen BS are of equal width and equidistant. The gaps R, r between the visible regions are available completely as reserve zones for the movement of the observer and—as explained further on—are filled for this purpose correspondingly with image information. The two image strips of a stereo pair now have the following spacing from each other on the screen BS:

q=L*P/(2P−L) (12)

and the periodic spacing of image strip pair to image strip pair is:

Q=2L*P/(2P−L)=2q (13)

The usable stereo channel width c=q has, projected in the observer eye plane BAE, a width which corresponds to the eye spacing:

C=P (14)

FIG. 5 shows the beam path in principle for a stereo channel. The visible region B in the image strip BSR is surrounded by reserve zones RZ which are delimited on the left and right by the channel boundaries (right channel boundary RKG, left channel boundary LKG). The eye can move laterally within the two positions 1 and 2 without the image pattern on the screen BS requiring to be changed for this purpose. The margin s for the lateral movement is according to FIG. 5:

s=P+L−(z/A)*L (15)

The further the stereo image SB is removed from the cylinder lenses ZL, the greater is this margin but the smaller is the surface area of the screen BS which can be used for the actually visible image. In theory, the usable surface becomes zero when A=z, i.e. the stereo image SB is situated in the observer eye plane BAE. The surface area of the screen BS is used to the maximum if the margin s is equal to zero, i.e. in the case of completely restricted freedom of movement of the observer. The image spacing Aₘᵢₙ between cylinder lens plane ZLE and stereo image plane SBE then is:

Aₘᵢₙ=z*L/(P+L) (16)

On the screen BS, the visible image regions b now abut against each other, there are no longer any reserve zones RZ. In the case of lateral or frontal movement of the observer, his eyes immediately see the incorrect stereo image: a movement without tracking is hence impossible.

Assignment of the Image Strips to the Lenses

FIG. 6 shows the geometric-optical imaging for two corresponding radiating image points LBP at the edge of the right and left stereo partial image (the light emanating from the radiating image points LBP is again indicated in light grey). Both image points LBP are imaged by two different cylinder lenses ZL at the same point in the stereo image plane SEE. The “central beams” begin at the radiating points on the screen BS, go through the centres of the cylinder lenses ZL and intersect at the common image point GBP. The lateral spacing of the two mutually assigned corresponding points on the screen BS results in

D=N_{L}*L*(A+a)/A (17)

N_{L}*L being the central spacing of the two cylinder lenses ZL which are used and N_{L} a natural number in the one-digit range. On the screen BS, the image strips BSR for the right stereo image are offset by the distance D relative to those for the left stereo image. Both stereo images cannot therefore use a zone of this width on the screen BS.

Image Strips and Pixel Arrangement, Tracking

The image strips BSR on the screen BS and the real image thereof in the stereo image plane SBE are side-inverted relative to each other. In order that the observer has a coherent image to view, the image strips BSR on the screen BS must be filled with image content in such a manner as FIG. 7 shows for one line of the stereo image SB.

Behind each cylinder lens ZL, respectively one strip with the width C is available on the screen BS for the two stereo images: only a partial region of width b thereof is visible for the observer. N pixels may fit into the distance c, M pixels into the visible region b thereof. The case is therefore that M≦N. FIG. 7 shows the assignment of the image strips BSR on the screen BS to those in the stereo image plane SBE; the visible pixels of a stereo image are numbered (the parameters not shown in FIG. 7 can be deduced from FIG. 1).

The writing-in of the pixels of one line of a stereo image into the image strips BSR on the image screen BS is demonstrated in FIG. 8. For example N=14 pixels are intended to fit into the strips of width c, M=8 of which are visible. The first N=14 pixels are then removed from the image line and written into the image strip BSR behind the first cylinder lens ZL. For the image strip BSR behind the second cylinder lens ZL, again N=14 pixels are taken and in fact from the pixel number M+1=9. The strip behind the third cylinder lens ZL receives from the image line the next N=14 pixels and in fact from the pixel number 2M+1=17. This assignment is continued such. In general there applies: for the i^{th} image strip BSR, subsequent pixels are taken from the image line N, beginning with the number (i−1)*M+1.

FIG. 8 shows an image line—surrounded above and below by the pixel groups read out therefrom. The numbers in the boxes correspond to the pixel numbers, only the last place respectively being indicated for the sake of clarity. The pixel group for the first image strip BSR is disposed above the image line, characterised by the index 1. The pixel group for the second image strip BSR is disposed below the image line, provided with the index 2. This indexing is continued thus. All the pixel groups mutually overlap.

When filling the image strips BS, it was not taken into consideration where the visible pixels are currently located—the centre of the image strip would be favourable. In the stereo image plane SBE, the pixels of the image strips BSR are projected one upon the other, as shown in FIG. 9A. The observer sees respectively the pixels of the grey boxes, i.e. a coherent stereo image SB. If he moves laterally, then in fact the visible and non-visible regions in the pixel groups are displaced—the stereo image SB thereby remains however unchanged—FIG. 9B illustrates this. If the observer moves towards the screen BS, pixels migrate from the visible region into the non-visible and vice versa. FIG. 9C and FIG. 9D show this. The observer always sees an undisturbed image. The width of the reserve zones thereby delimits the frontal movement region (distance from the screen BS).

The region for lateral movement can be increased by “tracking”: the observer position is determined and taken into account in the image strips by writing in the pixels. For the shifting of the pixel pattern, two narrow strips should be kept free for this purpose on the right and left edge of the panel. Likewise, a change in distance can be taken into account by z-tracking.

Practical Example of an Image Display Appliance

The following data must be specified for the design of an image display appliance BWG with a real stereo image SB: the observer spacing z, the image spacing A and the lateral movement margin s without tracking. In addition there is the spacing P between both eyes of an observer. The ratio of the distance s and the pupil spacing P is a measure of the free lateral movement:

γ=s/P (18)

This dimensionless dimension figure γ is intended to be used in the following for dimensioning. The suitable lens pitch L for the display then results according to equation (15):

L=A*P*(1−γ)/(z−A) (19)

The lens spacing for equidistant and equally wide image strips BSR on the screen BS is:

a_{sym}=A*z*(1−γ)/(2z−A*(3−γ)) (11)

and the expressions for the widths of the image strips BSR are:

q=A*p*(1−γ)/(2z−A*(3−γ)) (12)

b=A*P*(1−γ)²/(2z−A*(3−γ)) (6)

The “foot width” of the blurring is then

δ=A*(3−γ)/(2z)p_{A} (3)

(The original formula numbers were used again for the last four expressions.)

For an image display appliance BWG with the following specifications:

Z=750 mm A=200 mm P=65 mm the following values hence result:

| | L | a_{sym} | q | b | B | δ |
|---|---|---|---|---|---|---|
| γ | [mm] | [mm] | [mm] | [mm] | [mm] | [mm] |
| 0.4 | 14.1 | 91.8 | 7.9 | 4.78 | 10.3 | 1.0 |
| 0.5 | 11.8 | 75.0 | 6.5 | 3.25 | 8.6 | 1.0 |
| 0.6 | 9.4 | 58.8 | 5.0 | 2.04 | 6.9 | 0.9 |

In a typical implementation, virtual objects appear as real stereo images SB in a distance range of 60 mm to 220 mm in front of the screen BS and a minimum/maximum reach distance of approx. 500 mm to 700 mm relative to the observer.

### REFERENCE NUMBERS/FORMULA SIGNS

A image spacing (spacing ZLE-SBE)

Aₘᵢₙ minimum image spacing

a lens spacing (spacing BSE-ZLE)

a_{sym} lens spacing with equidistant BSR

B width BSR in SB

b instantaneous visible width BSR on the BS

BAE observer visual plane

BS screen

BSE screen plane

BSR image strip

BWG image display appliance

C usable stereo channel width, transmitted in the BAE

c usable stereo channel width on the BS

D lateral offset of the two partial images on the BS

FBP focused image point

G weighting function

GBP common image point

L lens pitch

LBP radiating image point

LKG left channel boundary

M number of pixels in the visible range b of the BSR

N number of pixels in the total range c of the BSR

N_{L} number ZL around which the two stereo images are seen offset

P spacing of the eyes of the observer from each other (65 mm)

p_{A} diameter of the pupil of the eye

Q spacing of BSR pair from BSR pair on the BS at a_{sym}

q spacing of the BSR pairs from each other on the BS at a_{sym}

R gap width between the BSR of one pair on the BS

r gap width between adjacent BSR pairs on the BS

RKG right channel boundary

RZ reserve zone

s lateral movement range without tracking

SB stereo image

SBE stereo image plane

S1 section transversely relative to the axis of the ZL

S2 section longitudinally relative to the axis of the ZL

z observer spacing reference value (spacing ZLE-BAE)

ZL cylinder lens

ZLE cylinder lens plane

ZLP cylinder lens plate

β imaging scale

γ ratio s/P (dimensionless dimension figure)

δ width G in SEE (blurring)

η width G on the BS

* multiplication sign

1. Autostereoscopic image display appliance comprising
a screen for displaying image information of a right-hand partial image for a right eye of an observer and of a left-hand partial image for a left eye of the observer in the form of alternately arranged image strips of the same width forming pairs of image strips,
each pair comprising one image strip belonging to the right partial image and one image strip belonging to the left partial image,
and a cylinder lens plate,
the cylinder lens plate comprising cylinder lenses and being disposed in front of the screen such that, in an observer eye plane, only the image information belonging to the right-hand partial image becomes visible for the right eye and only the image information belonging to the left-hand partial image becomes visible for the left eye,
each radiating point on the screen being imaged by one of the cylinder lenses as a real straight line in a stereo image plane between the cylinder lense plate and the observer eye plane,
each image strip being displayed side-inverted relative to a part of the partial image corresponding to this image strip and positioned with such gaps relative to its two adjacent image strips on the screen that the observer, in the stereo image plane, obtains a continuous display of the image information in the form of a floating real stereo image.

2. Autostereoscopic image display appliance according to claim 1,
wherein between the visible regions of an image strip for the right eye and the image strip for the left eye in one image strip pair a gap R is provided which is calculated from
R=a*(L+P)/z−L*a/A
and wherein between adjacent image strip pairs a gap r is provided which is calculated from
r=a*(2L−P)/z+L*(1−a/A)
with
a=lens spacing
A=image spacing
L=lens pitch
P=spacing of the eyes of the observer from each other
r=gap between adjacent image strip pairs
R=gap between the image strips of one image strip pair
z=observer spacing reference value.

3. Autostereoscopic image display appliance according to claim 2,
wherein the gap R between the image strips of an image strip pair and the gap r between adjacent image strip pairs are of equal size and the lens spacing is calculated at
a_{sym}=z*L/(2P−L)
with
a_{sym}=lens spacing with equidistant image strips.

4. Autostereoscopic image display appliance according to claim 3,
wherein
the lens spacing a_{sym} with equidistant image strips is calculated at
a_{sym}=A*z*(1−)/(2z−A*(3−))
with =s/P=dimensionless measure
s=lateral movement margin of the observer without tracking the image information
and the image strips and the lens pitch are calculated at:
q=A*P*(1−)/(2z−A*(3−))
b=A*P*(1−)²/(2z−A*(3−))
L=A*P*(1−)/(z−A)
with
b=currently visible width of an image strip on the screen
q=gap between the image strip pairs on the screen.

5. Autostereoscopic image display appliance according to claim 1,
wherein
lateral reserve zones are assigned to each image strip, with the image information of which reserve zones the gaps between the image strips are filled.

6. Autostereoscopic image display appliance according to claims 1,
wherein
a tracking device for adapting the image display to movements of the observer parallel to the screen and/or in space is provided.

7. Autostereoscopic image display appliance according to claim 1,
wherein
a detection device is provided for location detection of concrete objects in the region of the stereo image plane.

8. Autostereoscopic image display appliance according to claim 1,
wherein the
image strips and the cylinder lenses have a slanted run.
